(19) United States
(12) Patent Application Publication
(10) Pub. No.: US 2014/0147570 A1
(43) Pub. Date: May 29, 2014

(54) MOLASSES FLAVORED LOW CALORIE SWEETENER COMPOSITIONS

(71) Applicant: Teodor Gelov, Carmel, IN (US)

(72) Inventor: Teodor Gelov, Carmel, IN (US)

(73) Assignee: TC HEARTLAND LLC, Carmel, IN (US)

(21) Appl. No.: 14/131,732

(22) PCT Filed: Jul. 14, 2011
(86) PCT No.: PCT/US11/44031

§ 371 Date: Jan. 9, 2014

(51) Int. Cl. A23L 1/236

(52) U.S. Cl. CPC A23L 1/2364
USPC 426/548

(57) ABSTRACT

Disclosed is a brown colored low calorie sweetener composition suitable for use as a substitute for brown sugar, comprising a sugar alcohol having 4 to 12 carbon atoms, a high intensity sweetener, maltodextrin and a flavorant that imparts a flavor similar to molasses.

### BACKGROUND OF THE INVENTION

Brown sugar is a sucrose (sugar) product with a distinctive brown color due to the presence of molasses. It is either an unrefined or partially refined soft sugar consisting of sugar crystal with some residual molasses content, or it is produced by the addition of molasses to refined sugar. Natural brown sugar, or raw sugar (e.g., Turbinado, Muscovado, or Demerara sugar) is a brown sugar produced from the first crystallization of the sugar cane. There is more molasses in natural brown sugar, giving it a higher mineral content.

Brown sugar has a sweet and slightly tangy taste due to the presence of the molasses and is a popular sweetener in baked items such as breads, muffins, cake, pies, cookies, and pastries. Brown sugar is also commonly used as a sweetener in cooking when a slight spice and sweetness is desired, such as in barbecue baked beans, glazed ham, syrup, sweet potatoes and Swiss steak. It can also be melted with butter and blended to create a sweet glaze for turkey, ham or vegetables. The crumbly nature of brown sugar makes it a popular topping for food items such as oatmeal, yogurt, and fruit.

Despite its popularity and numerous food uses, people seek to avoid the use of brown sugar because they have a high caloric content and lead to weight gain when consumed in large amounts. Moreover, people with certain medical conditions, such as various forms of diabetes, must severely limit their brown sugar intake. In order to overcome these problems, researchers have been looking for molasses flavored sweetener compositions with very low or no caloric content, that are sweet but otherwise have a neutral taste and can be readily used in food stuff.

One approach used to make low calorie sugar substitutes is to incorporate an intense sweetening agent. Intense sweetening agents are natural or synthetic compounds, which have a sweetening intensity greater than sugar and which typically have a caloric value lower than sugar. Examples of intense sweetening agents include saccharin, cyclamate, acesulfame-K, proteins such as thaumatin, chlorodeoxysugar derivatives (e.g., sucralose), aspartame, alitame, and the like. Because intense sweeteners provide greater sweetening capacity than sugar, smaller amounts of intense sweeteners will provide sweetening intensity equivalent to larger amounts of sugar. Accordingly, intense sweeteners are widely used in place of sugar in many low calorie compositions. Intense sweeteners can provide compositions that have decreased caloric value as compared to sugar-sweetened compositions because far lower amounts of the intense sweetener are required to achieve optimum sweetness in the composition.

In some cases, intense sweetening agents have been blended or admixed with bulking agents to form a so-called bulked sweetener compositions. For example, Equal® Granular 0 Calorie Sweetener contains aspartame in combination with dextrose and maltodextrin. Sweet'N Low® Sugar Substitute contains saccharin in combination with dextrose and maltodextrin. Similarly Splenda® No Calorie Sweetener contains sucralose in combination with dextrose and maltodextrin. Similar blends of intense sweetening agents and bulking agents have been prepared as substitutes for brown sugar. For example, Sweet'N Low® Brown is a no-calorie substitute containing saccharin in combination with dextrose, natural molasses flavoring, caramel color, cream of tartar and calcium silicate (as an anti-caking agent). Similarly, SugarTwin® Granulated Brown (United States) is a no calorie brown sugar substitute and contains sodium saccharin in combination with maltodextrin, calcium chloride, artificial flavorant and caramel color.

Intense sweetening agents have alternatively been blended with sugar alcohols or polyols such as erythritol, isomalt, lactitol, maltitol, mannitol, sorbitol, and xylitol. Most polyols are incompletely digested and poorly absorbed and so have caloric values that are lower than that of sugar. An example of a brown sugar substitute containing a sugar alcohol is DiabetiSweet® Brown Sugar Substitute, a low-calorie brown sugar substitute, containing acesulfame-K in combination with isomalt, natural and artificial flavorants, unhydrogenated vegetable oil, and colorants.

Intense sweetening agents have also been blended with sugar or brown sugar to form low calorie sweetener compositions. For example, Splenda® Brown Sugar Blend is a low-calorie substitute containing a blend of natural brown sugar with sucralose, dextrose and maltodextrin where one-half teaspoon of Splenda® Brown Sugar Blend contains 8 calories and is equivalent in sweetness to 1 teaspoon of brown sugar, which contains 16 calories.

Despite the availability of low calorie and no calorie brown sugar substitutes, consumers complain that such brown sugar substitutes do not have the same sweetness as brown sugar, have an undesirable aftertaste, and/or do not have the same look, texture or feel (e.g., mouthfeel) as brown sugar. In addition, consumers have found that such brown sugar substitutes cannot readily be used in baking applications due to problems with temperature instability, undesirable aftertaste, and/or undesirable texture and structure of the resulting baked goods.

Thus, there remains an unmet need for a low calorie or no calorie brown sugar substitute that has equivalent sweetness to brown sugar, and has the look, taste, and feel of brown sugar. In addition, there remains an unmet need for a low calorie or no calorie brown sugar substitute that has equivalent volume to brown sugar such that it can be used as a brown sugar substitute in baking applications, and has the look, taste, texture, and flow properties of brown sugar.

### BRIEF SUMMARY OF THE INVENTION

The invention provides a molasses flavored sweetener composition that is low-calorie or no-calorie and that substantially looks, tastes, bakes, and feels like brown sugar. The sweetener composition of the invention is a bulk sweetener composition that is equal to brown sugar on a teaspoon to teaspoon and cup to cup basis and which can be used as a 1:1 volume baking substitute for brown sugar.

The sweetener composition of the invention preferably is a low-calorie or no-calorie composition comprising, consisting essentially of, or consisting of at least one sugar alcohol having 4 to 12 carbon atoms (e.g., xylitol), at least one high intensity sweetener (e.g., sucralose), a carrier/bulking agent (e.g., maltodextrin), and a brown colored flavorant (e.g., molasses) or brown colorant/flavorant combination (e.g., molasses flavorant/brown colorant).

In other embodiments, the sweetener composition of the invention comprises, consists essentially of, or consists of at least one sugar alcohol having 4 to 12 carbon atoms, at least one high intensity sweetener, maltodextrin, and a brown colored flavorant (e.g., molasses) or brown colorant/flavorant combination (e.g., molasses flavorant/brown colorant).

In yet other embodiments, the sweetener composition of the invention comprises, consists essentially of, or consists of, at least one sugar alcohol having 4 to 12 carbon atoms, at least one high intensity sweetener, maltodextrin, a flavoring agent (e.g., a molasses flavoring agent), and a brown colorant, wherein the sweetener composition has a bulk density of about 0.2 g/ml to about 0.4 g/ml.

In a preferred embodiment, the sweetener composition of the invention comprises, consists essentially of, or consists of at least one sugar alcohol having 4 to 12 carbon atoms, at least one high intensity sweetener, maltodextrin, and dry molasses. In a particularly preferred embodiment, the sweetener composition of the invention is a low calorie or no calorie brown sugar-like composition comprising, consisting essentially of, or consisting of, xylitol, sucralose, maltodextrin and dry molasses.

In another preferred embodiment, the invention provides a sweetener composition consisting essentially of about 50 wt. % to about 70 wt. % xylitol, about 0.05 wt. % to about 2 wt. % sucralose, about 20 wt. % to about 40 wt. % maltodextrin, and about 5-15 wt. % dry molasses. In yet another preferred embodiment, the invention provides a sweetener composition consisting essentially of about 63 wt. % xylitol, about 0.25 wt. % sucralose, about 26.75 wt. % maltodextrin, and about 10 wt. % dry molasses, wherein the composition desirably is granular.

Desirably the sweetener composition of each of these embodiments has a finished product bulk density of about 0.1 g/ml to about 0.5 g/ml (e.g., about 0.2 g/ml to about 0.4 g/ml or about 0.3 g/ml). In addition, the sucralose desirably is affixed to the maltodextrin, although in some embodiments the sucralose can be affixed to the xylitol.

### DETAILED DESCRIPTION OF THE INVENTION

The invention relates to flavored low-calorie and no-calorie sweetener compositions, which are suitable for use as a substitute for brown sugar, particularly in the preparation of baked foods, and other prepared liquid, solid and semisolid comestibles and food stuffs. In addition, the invention is directed to a low-calorie or no-calorie sweetener composition comprising at least one sugar alcohol (preferably xylitol) in combination with at least one high intensity sweetener (preferably sucralose), a carrier and/or bulking agent (preferably maltodextrin) and a brown colored flavorant (or flavorant/brown colorant combination, e.g., dry molasses) that imparts a flavor similar to or the same as molasses.

In some embodiments, the sweetener composition consists essentially of at least one sugar alcohol (e.g., xylitol), sucralose, maltodextrin, and molasses (e.g., dry molasses powder) or a flavorant/brown colorant combination that imparts a flavor similar to or the same as molasses. When the composition comprises molasses flavorant/brown colorant combination, the composition desirably is free or substantially free of a nutritive sugar (e.g., contains less than 1 wt. % nutritive sugar, less than 0.5 wt. % nutritive sugar, or less than 0.1 wt. % nutritive sugar). When the composition comprises dry molasses, the composition desirably is free or substantially free of a nutritive sugar beyond that which is present in the dry molasses.

In some preferred embodiments the sweetener composition comprises or consists essentially of xylitol, sucralose, maltodextrin and dry molasses. In other preferred embodiments, the sweetener composition is a low calorie sweetener composition consisting essentially of a brown colored flavorant (e.g., molasses, preferably powdered molasses), a sugar alcohol having 4 to 12 carbon atoms, a high intensity sweetener, and maltodextrin.

In some embodiments, the sweetener composition is a low calorie composition. In accordance with the U.S. FDA's Guidance for Industry: A Food Labeling Guide, the term “low-calorie” means that the food contains less than 40 calories per reference amount customarily consumed (RACC) or per 50 g if RACC is small. In an embodiment, the sweetener composition of the invention has a caloric content of less than 200 calories or less per cup or about 4 calories or less per teaspoon.

In other preferred embodiments, the sweetener composition is a no-calorie composition. In accordance with the U.S. FDA's Guidance for Industry: A Food Labeling Guide, the term “no calorie” means that the food contains less than 5 calories per reference amount customarily consumed and per labeled serving. The serving size can be any suitable amount, but typically is between about 1 and about 4 grams. Preferably the serving size is between about 1 gram and about 2 grams. In particularly preferred embodiments, the sweetener composition contains less than 5 calories per 1.5 g.

The sweetener composition of the invention is intended to be used as a low calorie or no calorie substitute for natural brown sugar, in baking, cooking or tabletop use. Accordingly it is important that the sweetener composition of the invention has the same sweetness and flavor as brown sugar, while be substitutable volume for volume. Desirably one cup of the sweetener composition of the invention has the same sweetness as one cup of brown sugar (i.e., it can be used as a 1:1 volume baking substitute for brown sugar). In addition, it is desirably that about 1.5 grams of the sweetener composition of the invention has equivalent sweetness to about 1 teaspoon (or about 4 grams) of natural brown sugar.

Applicants have discovered that this can be accomplished by combining in appropriate ratios at least one sugar alcohol, at least one high intensity sweetener, a carrier and/or bulking agent (typically maltodextrin) and molasses flavorant (e.g., dry molasses), and by ensuring that the finish product bulk density of the sweetener composition has a finished product bulk density of about 0.1 g/ml to about 0.5 g/ml, or about 0.2 g/ml to about 0.4 g/ml, preferably about 0.25 g/ml to about 0.35 g/ml, or more preferably about 0.28 g/mol to about 0.32 g/ml (e.g., about 0.3 g/ml).

The high intensity sweetener is a substance that provides a high sweetness per unit mass as compared to sucrose and provides little or no nutritive value. Many high intensity sweeteners are known to those skilled in the art and any can be used in the present invention. Examples of high intensity sweeteners for use in the present invention include sucralose (4,1′,6′-trichloro-4,1′,6′-trideoxygalactosugar), acesulfame (e.g., acesulfame potassium), alitame, aspartame, salt of aspartame-acesulfame, neotame, cyclamate, dulcin, glucin, neohesperidin dihydrochalcone, glycyrrhizin, steviol glycosides (e.g., stevioside, rebaudioside A, rebaudioside C, dulcoside A), extract of Dioscoreophyllum cumminsii (e.g., monellin), extract of the fruit of Pentadiplandra brazzeana (e.g., brazzein), pentadin, thaumatin, 5-Nitro-2-propoxyaniline (i.e., P-4000), saccharin, hernandulcin, curculin, mabinlin 1, mabinlin 2, mabinlin 3, mabinlin 4, mogroside, salts, derivatives, and any combination thereof. A preferred high intensity sweetener according to the present invention is sucralose, a sweetener with a sweetness intensity approximately 600 times that of sugar. Other preferred high intensity sweeteners according to the present invention include steviol glycosides (e.g., stevioside, rebaudioside A, rebaudioside C, dulcoside A), extract of the fruit of Pentadiplandra brazzeana (e.g., brazzein), aspartame, neotame, and combinations thereof. Preferably the high intensity sweetener comprises or consists of sucralose and is used in combination with xylitol as the sugar alcohol.

The sweetener composition of the invention can contain from about 0.01 wt. % to about 3.5 wt. % of a high intensity sweetener. Preferably, the sweetener composition comprises from about 0.05 wt. % to about 2 wt. %, even more preferably from about 0.1 wt. % to about 1 wt. % of a high intensity sweetener based on the weight of the sweetener composition. If the only high intensity sweetener used is sucralose, the sweetener composition of the invention preferably contain from about 0.05 wt. % to about 1 wt. % of sucralose. More preferably, the sweetener composition of the invention contains from about 0.1 wt. % to about 0.5 wt. %, even more preferably from about 0.2 wt. % to about 0.3 wt. % of sucralose based on the weight of the sweetener composition.

The sugar alcohol is a polyol derived from a carbohydrate whose carbonyl group (aldehyde or ketone) has been reduced to a primary or secondary hydroxyl group. Sugar alcohols can be classified by chemical structure as monosaccharide-derived, disaccharide-derived, or polysaccharide-derived mixtures. The sugar alcohol desirably is a polyol having 4 to 12 carbon atoms, for example, the sugar alcohol can have 4 carbon atoms, 5 carbon atoms, 6 carbon atoms, 7 carbon atoms, 8 carbon atoms, 9 carbon atoms, 10 carbon atoms, 11 carbon atoms, or 12 carbon atoms. In some embodiments, the sugar alcohol desirably has 4 carbons. In other embodiments, the sugar alcohol has 5 carbons. In yet other embodiments, the sugar alcohol has 6 carbons. In yet still other embodiments, the sugar alcohol has 12 carbons.

Typically the sugar alcohol is selected from the group consisting of erythritol, threitol, arabitol, xylitol, ribitol, mannitol, sorbitol, dulcitol, iditol, isomalt, maltitol, and lactitol, and any combination thereof. Preferably the sugar alcohol is a monosaccharide- or disaccharide-derived polyol selected from maltitol, mannitol, xylitol, erythritol, and combinations thereof. More preferably the sugar alcohol comprises xylitol, and even more preferably the sugar alcohol is xylitol. Xylitol has the same sweetness as sugar, has virtually no aftertaste, is slowly absorbed and has a very low glycemic index of 13. In addition xylitol is a “tooth-friendly,” nonfermentable sugar alcohol that has dental health benefits in preventing tooth caries, inhibiting bacteria and reducing plaque. Where combinations of xylitol and another sugar alcohol are used, preferably the sugar alcohol comprises xylitol in combination with maltitol, mannitol, and/or erythritol.

The amount of sugar alcohol used in the flavored sweetener composition can be any suitable amount. Typically, the amount of sugar alcohol is between about 40 wt. % to about 80 wt. %, preferably about 45 wt. % to about 75 wt. %, or about 50 wt. % to about 70 wt. %, based on the total weight of the composition. The sweetener composition preferably comprises about 55 wt. % to about 68 wt. % (e.g., about 60 to about 65 wt. % or about 62 to about 64 wt. %) sugar alcohol, based on the total weight of the composition.

Desirably the identity and amount of the sugar alcohol used in the sweetener composition of the invention is selected such that no anti-flatulence agents are required. Anti-flatulence agents can disrupt the flavor, texture, and density of the sweetener composition of the invention. Accordingly, the sweetener composition of the invention preferably does not contain an anti-flatulence agent.

The carrier and/or bulking agent is a non-sugar alcohol carbohydrate carrier selected to provide bulk to dry mix compositions with minimum density. Typically the non-sugar alcohol bulking agent is selected from the group consisting of maltodextrin, dextrose, fructose, galactose, lactose, maltose, glucans, fructans, inulin, polydextrose, xylans, galactans, celluloses, starches, resistant starches, diatomaceous earth, lignins, polymers and co-polymers formed from coumaryl, guaiacyl, coniferyl, or sinapyl alcohols, hemicelluloses, amylase, amylase pectin, and any combination thereof. Desirably the carrier is a maltodextrin carbohydrate. In a preferred embodiment, the sucralose is affixed to (i.e., intimately associated with) and/or adhered to the carbohydrate carrier (e.g., maltodextrin) such as by spray drying. The sweetener composition of the invention preferably comprises maltodextrin (e.g., maltodextrin M700, which has a bulk density of about 0.13 g/cm³). Alternatively the sweetener composition of the invention can comprise a combination of dextrose and maltodextrin, such as an agglomerated dextrose consisting of dextrose monohydrate and maltodextrin, sold as Unidex® (Corn Products U.S.).

The amount of carrier and/or bulking agent used in the sweetener composition of the invention can be any suitable amount, e.g., about 10 wt. % to about 40 wt. %, e.g., about 15 wt. % to about 35 wt. %, or about 18 wt. % to about 32 wt. %, based on the total weight of the composition. Typically, the amount of carrier and/or bulking agent is about 20 wt. % to about 35 wt. %, about 22 wt. % to about 30 wt. %, or about 24 wt. % to about 28 wt. % (e.g., about 26.75 wt. %), based on the total weight of the composition.

The sweetener composition of the invention is to be used as a low-calorie or no-calorie substitute for natural brown sugar. Accordingly the sweetener composition of the invention contains a brown colored flavorant or flavorant/brown colorant combination to impart the taste of molasses, which is the flavor component of brown sugar. Desirably the brown colored flavorant or flavorant/brown colorant combination is in the form of a powder, optionally in combination with a carrier as described above (e.g., maltodextrin).

The sweetener composition typically comprises molasses, including either molasses from sugar cane or from sugar beet. However, in other embodiments, other brown-colored flavorants can be used in combination with the molasses, including, for example, brown sugar flavored syrups/extracts, dark (or black) treacle, dark honey, dark corn syrup, sorghum syrup, or maple syrup. Desirably the brown colored flavorant or flavorant/brown colorant combination is selected such that it closely resembles the flavor of molasses present in natural brown sugar. Preferably the sweetener composition comprises molasses, although in some embodiments it may be desirable to use imitation molasses or honey powder.

Desirably the brown colored flavorant is molasses. Preferably the brown colored flavorant is dry molasses, and particularly preferred is dry molasses in a powder form (e.g., a dried powder form such as SWEET N NEAT® 4000 DRY MOLASSES POWDER, DRI-MOL® DRY MOLASSES POWDER or DRI-MOL® 604 DRY MOLASSES POWDER sold by Archer Daniels Midland Company; or Code 1075 or 1015 Dry Molasses from Premier Malt Products, Inc.). In some especially preferred embodiments, the molasses powder consists of spray dried molasses power (e.g., molasses spray dried with, or blended with, maltodextrin such as SWEET N NEAT® 65 DRY MOLASSES POWDER sold by Archer Daniels Midland Company, SPRAY DRIED MEDIUM MOLASSES (CODE # 45000) Kosher PARVE sold by Specialty Products and Technology, Inc., or Code 1075 Dry Molasses from Premier Malt Products, Inc.). Preferably the dry molasses powder comprises dry molasses in combination with a carrier, typically maltodextrin. More preferably the dry molasses powder comprises dry molasses in combination with maltodextrin.

Desirably the dry powder molasses has a moisture content of less than about 10 wt. % (e.g., less than about 8 wt. %, or less than about 5 wt. %), based on the total weight of the molasses powder. More preferably the dry powder molasses has a moisture content of about 1 wt. % to about 5 wt. % (e.g., about 2 wt. % to about 4 wt. %), based on the total weight of the molasses powder.

The brown colored flavorant or flavorant/brown colorant combination preferably has a calorie count of between about 3 calories/g and 4 calories/g (e.g., about 3.4 to about 3.8 calories/g, or about 3.6 to about 3.7 calories/g).

The amount of brown colored flavorant or flavorant/brown colorant combination used in the flavored sweetener composition of the invention can be any suitable amount and will depend on the particular brown colored flavorant or flavorant/brown colorant combination selected. When the brown colored flavorant molasses is used, the sweetener composition typically contains about 1 wt. % to about 20 wt. %, e.g., about 5 wt. % to about 15 wt. %, or about 8 wt. % to about 12 wt. %, or about 9 wt. % to about 11 wt. % (e.g., about 10 wt. %), based on the total weight of the composition.

The high intensity sweetener optionally can be spray dried, coated onto, adhered to or otherwise affixed to (i.e., intimately associated with) the carrier and/or bulking agent and/or sugar alcohol and/or brown colored flavorant or flavorant/brown colorant combination. In preferred embodiments, the high intensity sweetener (e.g., sucralose) is spray dried and/or coated onto the carrier and/or bulking agent (e.g., maltodextrin). For example, it is desirable for the high intensity sweetener (e.g., sucralose) and carrier and/or bulking agent (e.g., maltodextrin) to be present in the sweetener composition of the invention as a mixture of maltodextrin and sucralose spray-dried together.

In a preferred embodiment, the sugar alcohol is xylitol and the carbohydrate carrier is maltodextrin. In addition, it is preferred that the high intensity sweetener (e.g., sucralose) is affixed to and/or adhered to the maltodextrin such as by spray drying. In an especially preferred sweetener composition of the invention, the composition consists essentially of xylitol, sucralose, maltodextrin, and molasses, wherein the sucralose is affixed and/or adhered to the maltodextrin, more preferably by spray drying. Desirably the sucralose and maltodextrin are co-dissolved and spray dried to form flaky solid having bulk density of about 0.06 g/ml to about 0.1 g/ml (e.g., about 0.07 g/ml to about 0.09 g/ml). In addition, it is preferred that the finished product has density of about 0.1 g/ml to about 0.5 g/ml or about 0.2 g/ml to about 0.4 g/ml (e.g., about 0.25 g/ml to about 0.35 g/ml, or about 0.28 g/ml to about 0.32 g/ml).

In another preferred sweetener composition of the invention, the composition consists essentially of about 50 wt. % to about 70 wt. % xylitol, about 0.1 wt. % to about 0.5 wt. % sucralose, about 15 wt. % to about 35 wt. % maltodextrin, and about 1 wt. % to 20 wt. % molasses powder, based on the total weight of the composition, wherein the sucralose is affixed to and/or adhered to the maltodextrin. In yet another preferred sweetener composition, the composition consists essentially of, or consists of, about 60 wt. % to about 65% xylitol, about 0.2 wt. % to about 0.3 wt. % sucralose, about 22 wt. % to about 30 wt. % maltodextrin, and about 5 wt. % to about 15 wt. % molasses powder (e.g., about 62 wt. % to about 64 wt. % xylitol, about 0.2 wt. % to about 0.3 wt. % sucralose, about 26 wt. % to about 27 wt. % maltodextrin, and about 9 to about 11 wt. % molasses powder), based on the total weight of the composition. The sweetener composition of the invention desirably is granular.

Desirably the sweetener composition of the invention has a moisture content of about 15 wt. % or less, more preferably about 10 wt. % or less (e.g., about 9 wt. % or less).

The foregoing compositions may be made by any suitable processes. In some embodiments, the sweetener composition of the invention is prepared by dry blending, e.g., using a conventional paddle blender or twinshell V blender and/or other suitable blender, many of which are known in the art. In other embodiments, the sweetener composition of the invention is prepared by spray drying the sucralose and the carrier and/or bulking agent (e.g., maltodextrin) together and then dry blending the resultant mixture with the sugar alcohol (e.g., xylitol) and molasses (e.g., dry molasses powder or molasses flavorant/brown colorant combination). Suitable spray dryers include any conventional spray dryer, many of which are known in the art.

In some embodiments, the sweetener composition of the invention is free of dextrose. In other embodiments, the sweetener composition of the invention is free of isomalt. In yet other embodiments, the sweetener composition of the invention is free of saccharin. In still other embodiments, the sweetener composition of the invention is free of acesulfame K.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A low calorie sweetener composition comprising :
(a) at least one sugar alcohol having 4 to 12 carbon atoms,
(b) at least one high intensity sweetener,
(c) maltodextrin, and
(d) dry molasses
wherein the sweetener composition has a bulk density of about 0.2 g/ml to about 0.4 g/ml.

2. The low calorie sweetener composition of claim 1, wherein the sweetener composition has a bulk density of about 0.28 g/ml to about 0.32 g/ml.

3. The low calorie sweetener composition of claim 1, wherein the sweetener composition has less than 5 calories per 1.5 grams of the composition.

4. The low calorie sweetener composition of claim 1, wherein the at least one sugar alcohol having 4 to 12 carbon atoms is selected from the group consisting of erythritol, xylitol, mannitol, maltitol, and any combination thereof.

5. The low calorie sweetener composition of claim 1, wherein the at least one sugar alcohol is xylitol.

6. The low calorie sweetener composition of claim 1, wherein the at least one high intensity sweetener is selected from the group consisting of sucralose, aspartame, alitame, neotame, brazzein, steviol glycosides, and any combination thereof.

7. The low calorie sweetener composition of claim 1, wherein the at least one high intensity sweetener is sucralose.

8. The low calorie sweetener composition of claim 1, wherein the composition consists essentially of dry molasses, xylitol, maltodextrin, and sucralose.

9. The low calorie sweetener composition of claim 1, wherein the dry molasses is a spray dried molasses powder.

10. The low calorie sweetener composition of claim 8, wherein the maltodextrin and sucralose are present as a mixture of maltodextrin and sucralose spray-dried together.

11. The low calorie sweetener composition of claim 10, wherein the spray dried mixture of maltodextrin and sucralose has a bulk density of about 0.07 g/ml to about 0.09 g/ml.

12. The low calorie sweetener composition of claim 1, wherein the maltodextrin has a bulk density of about 0.13 g/cm3.

13. The low calorie sweetener composition of claim 1, wherein the dry molasses is present in an amount of about 5 to about 20%, the at least one sugar alcohol is present in an amount of about 50 to about 70%, maltodextrin is present in an amount of about 20 to about 40%, and the at least one high intensity sweetener is present in an amount of about 0.5 to about 2%, by weight of the composition.

14. The low calorie sweetener composition of claim 1, wherein the dry molasses is present in an amount of about 8 to about 12%, the at least one sugar alcohol is present in an amount of about 60 to about 65%, maltodextrin is present in an amount of about 22 to about 30%, and the at least one high intensity sweetener is present in an amount of about 0.1 to about 0.5%>, by weight of the composition.

15. The low calorie sweetener composition of claim 1, wherein the dry molasses is present in an amount of about 9 to about 11%, the at least one sugar alcohol is present in an amount of about 62 to about 64%, maltodextrin is present in an amount of about 26 to about 27% and the at least one high intensity sweetener is present in an amount of about 0.2 to about 0.3%), by weight of the composition.

16. A low calorie sweetener composition comprising:
(a) at least one sugar alcohol having 4 to 12 carbon atoms,
(b) at least one high intensity sweetener,
(c) maltodextrin,
(d) a flavoring agent; and
(e) a brown colorant;
wherein the sweetener composition has a bulk density of about 0.2 g/ml to about 0.4 g/ml.
